(19) United States
(12) Patent Application Publication
(10) Pub. No.: US 2007/0251090 A1
(43) Pub. Date: Nov. 1, 2007

(54) Methods and apparatus for fabricating blades

(75) Inventors: Sjef Van Breugel, Enschede (NL); Jan Willem Bakhuis, Hondsdraf (NL); Andy John Billen, Daarlerveen (NL)

Correspondence Address: PATRICK W. RASCHE (22402), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/413,391

(22) Filed: Apr. 28, 2006

(51) Int. Cl. B23P 15/02

(52) U.S. Cl. 29/889.7

(57) ABSTRACT

A method for fabricating a blade using a mold having a shape corresponding to a predetermined finished shape of at least a portion of the blade. The method includes stacking a plurality of layers of a material in the mold, stacking at least one component with the stack of the plurality of layers, wherein the component is a composite comprising a cured resin and at least one layer of fiber, and laminating the stack of the plurality of layers and the component.

### BACKGROUND OF THE INVENTION

This invention relates generally to blades that may be useful as wind turbine rotor blades, and more specifically to methods and apparatus for fabricating to blades.

Generally, a wind turbine includes a rotor having multiple blades. The rotor is mounted on a housing or nacelle, which is positioned on top of a truss or tubular tower. Utility grade wind turbines (i.e., wind turbines designed to provide electrical power to a utility grid) can have large rotors (e.g., 30 or more meters in diameter). Blades on these rotors transform wind energy into a rotational torque or force that drives one or more generators, generally but not always rotationally coupled to the rotor through a gearbox. The gearbox steps up the inherently low rotational speed of the turbine rotor for the generator to efficiently convert mechanical energy to electrical energy, which is fed into a utility grid. Gearless direct drive turbines also exist.

At least some known wind turbine rotor blades are fabricated by laminating a stack of layers together, for example layers of fiber, metal, plastic, and/or wood, to form a composite shell having a predetermined aerodynamic shape. The laminated rotor blade shell may also include other components laminated with the layers of fiber, metal, plastic, and/or wood. For example, core material may be sandwiched between two adjacent layers in the stack to strengthen the rotor blade against, for example, buckling from wind loads. Moreover, and for example, portions of the laminated rotor blade shell adjacent internal supporting spars may include one or more supporting layers of fabric, metal, plastic, and/or wood, sometimes referred to as spar caps, to strengthen the portions for connection thereof to the internal spars. Furthermore, and for example, portions of the laminated rotor blade shell adjacent a root section of the rotor blade may include one or more supporting layers of fabric, plastic, metal, and/or wood for strengthening the root section to reduce or eliminate damage thereto from shear forces and/or rotor torque.

At least some known laminated rotor blade shells are fabricated by laminating a stack of the fabric, metal, plastic, and/or wood layers, and any other component layers, together with a resin. For example, the layers may be stacked in a mold having the predetermined aerodynamic shape. Alternatively, and for example, the layers may be wound around a mandrel having the predetermined aerodynamic shape to create the stack. The resin may be infused into the layers, for example using a vacuum bag system, which may also facilitate forming the layers to the mold shape. Alternatively, the layers may each be impregnated and/or coated with resin prior to stacking in the mold or winding around the mandrel. However, it may be difficult and/or time-consuming to form some components of rotor blade shells, for example spar caps, core material, and/or root section supports, such that they will both sufficiently support the rotor blade shell and be formed into the predetermined aerodynamic shape, for example because of a size of the layers, local variations in resin content, local variations in a curvature of the layers, and/or local variations in strains exerted on the shell during fabrication thereof.

### BRIEF DESCRIPTION OF THE INVENTION

In one aspect, a method is provided for fabricating a blade using a mold having a shape corresponding to a predetermined finished shape of at least a portion of the blade. The method includes stacking a plurality of layers of a material in the mold, stacking at least one component with the stack of the plurality of layers, wherein the component is a composite comprising a cured resin and at least one layer of fiber, and laminating the stack of the plurality of layers and the component.

In another aspect, a method is provided for fabricating a blade using a mold having a shape corresponding to a predetermined finished shape of at least a portion of the blade. The method includes stacking a plurality of layers of a material in the mold, stacking at least one component with the stack of the plurality of layers, wherein the component comprises a shape that corresponds to the predetermined finished shape of at least a portion of the blade, and laminating the stack of the plurality of layers and the component.

In another aspect, a method is provided for fabricating a blade using a filament winding process. The method includes providing a mandrel having a shape corresponding to a predetermined finished shape of at least a portion of the blade, winding fiber around the mandrel to form a plurality of layers of the fiber, positioning at least one component adjacent at least one layer of the plurality of layers of fiber, wherein the component comprises at least one of a shape that corresponds to the predetermined finished shape of at least a portion of the blade and at least one layer of fiber infused with a cured resin, and laminating the plurality of fiber layers and the component.

### BRIEF DESCRIPTION OF THE DRAWINGS

FIG. 1 is a perspective view of an exemplary wind turbine.

FIG. 2 is a perspective view of an exemplary rotor blade for use with the wind turbine shown in FIG. 1.

FIG. 3 is a cross-sectional view of the rotor blade shown in FIG. 2 and taken about line 3-3 of FIG. 2.

FIG. 4 is a flowchart illustrating an exemplary embodiment of a method for fabricating the rotor blade shown in FIGS. 2 and 3.

FIG. 5 is a flowchart illustrating another exemplary embodiment of a method for fabricating the rotor blade shown in FIGS. 2 and 3.

### DETAILED DESCRIPTION OF THE INVENTION

As used herein, the term “blade” is intended to be representative of any device that provides reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power. As used herein, the term “windmill” is intended to be representative of any wind turbine that uses rotational energy generated from wind energy, and more specifically mechanical energy converted from kinetic energy of wind, for a predetermined purpose other than generating electrical power, such as, but not limited to, pumping a fluid and/or grinding a substance.

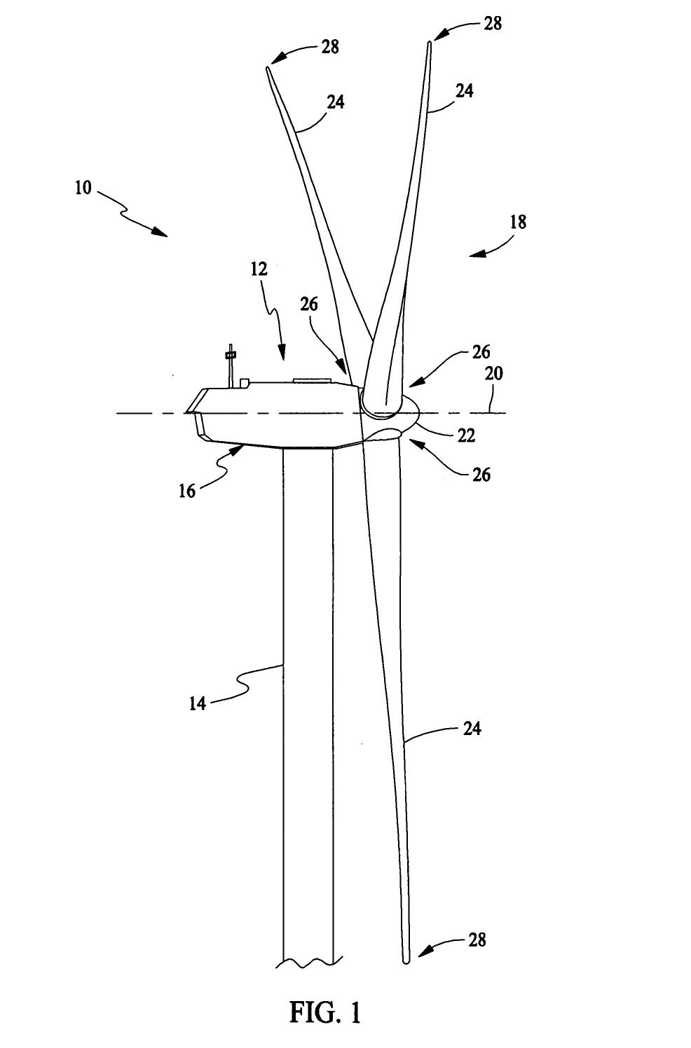

FIG. 1 is a perspective of an exemplary embodiment of an exemplary wind turbine 10. Wind turbine 10 described and illustrated herein includes a wind generator 12 for generating electrical power from wind energy. However, in some embodiments, wind turbine 10 may include, in addition or alternative to wind generator 12, any type of wind turbine, such as, but not limited to, a windmill (not shown). Moreover, wind turbine 10 described and illustrated herein includes a horizontal-axis configuration. However, in some embodiments, wind turbine 10 may include, in addition or alternative to the horizontal-axis configuration, a vertical-axis configuration (not shown). Wind turbine 10 may be coupled to a power grid (not shown) for receiving electrical power therefrom to drive operation of wind turbine 10 and/or its associated components and/or for supplying electrical power generated by wind turbine 10 thereto. Although only one wind turbine 10 is shown in FIG. 1, in some embodiments a plurality of wind turbines 10 may be grouped together, sometimes referred to as a “wind farm”.

In some embodiments, wind generator 12 is mounted on a tower 14, however, in some embodiments wind turbine 10 includes, in addition or alternative to tower-mounted wind generator 12, a wind generator (and/or other type of wind turbine) adjacent the ground and/or a surface of water. The height of tower 14 may be selected based upon factors and conditions known in the art. Wind generator 12 includes a body 16, sometimes referred to as a “nacelle”, and a rotor (generally designated by 18) coupled to body 16 for rotation with respect to body 16 about an axis of rotation 20. Rotor 18 includes a hub 22 and a plurality of blades 24 (sometimes referred to as “airfoils”) extending radially outwardly from hub 22 for converting wind energy into rotational energy. Each blade 24 extends between a root section 26 coupled to rotor hub 22 and a tip section 28. Although rotor 18 is described and illustrated herein as having three blades 24, rotor 18 may have any number of blades 24. Blades 24 may each have any length and/or width (whether described herein). For example, in some embodiments one or more rotor blades 24 are about 0.5 meters long, while in some embodiments one or more rotor blades 24 are about 50 meters long. Other examples of blade 24 lengths include 10 meters or less, about 20 meters, about 34 meters, about 37 meters, and about 40 meters. Examples of blade widths include between about 0.5 meters and about 10 meters.

Despite how rotor blades 24 are illustrated in FIG. 1, rotor 18 may have blades 24 of any shape, and may have blades 24 of any type and/or any configuration, whether such shape, type, and/or configuration is described and/or illustrated herein. One example of another type, shape, and/or configuration of rotor blades 24 is a ducted rotor (not shown) having a turbine (not shown) contained within a duct (not shown). Another example of another type, shape, and/or configuration of rotor blades 24 is a darrieus wind turbine, sometimes referred to as an “eggbeater” turbine. Yet another example of another type, shape, and/or configuration of rotor blades 24 is a savonious wind turbine. Even another example of another type, shape, and/or configuration of rotor blades 24 is a traditional windmill for pumping water, such as, but not limited to, four-bladed rotors having wooden shutters and/or fabric sails. Moreover, wind turbine 10 may, in some embodiments, be a wind turbine wherein rotor 18 generally faces upwind to harness wind energy, and/or may be a wind turbine wherein rotor 18 generally faces downwind to harness energy. Of course, in any embodiments, rotor 18 may not face exactly upwind and/or downwind, but may face generally at any angle (which may be variable) with respect to a direction of the wind to harness energy therefrom.

Wind generator 12 includes an electrical generator (not shown) coupled to rotor 18 for generating electrical power from the rotational energy generated by rotor 18. The electrical generator 26 may be any suitable type of electrical generator, such as, but not limited to, a wound rotor induction generator. General operation of the electrical generator to generate electrical power from the rotational energy of rotor 18 is known in the art and therefore will not be described in more detail herein. In some embodiments, wind turbine 10 may include one or more control systems (not shown), actuating mechanisms, and/or sensors (not shown) coupled to some or all of the components of wind generator 12 for generally controlling operation of wind generator 12 and/or as some or all of the components thereof (whether such components are described and/or illustrated herein). For example, control system(s), actuating mechanism(s), and/or sensor(s) may be used for, but are not limited to, overall system monitoring and control including, for example, pitch and speed regulation, high-speed shaft and yaw brake application, yaw and pump motor application, and/or fault monitoring. Alternative distributed or centralized control architectures may be used in some embodiments. General operation of wind turbine 10, and more specifically wind generator 12, is known in the art and therefore will not be described in more detail herein.

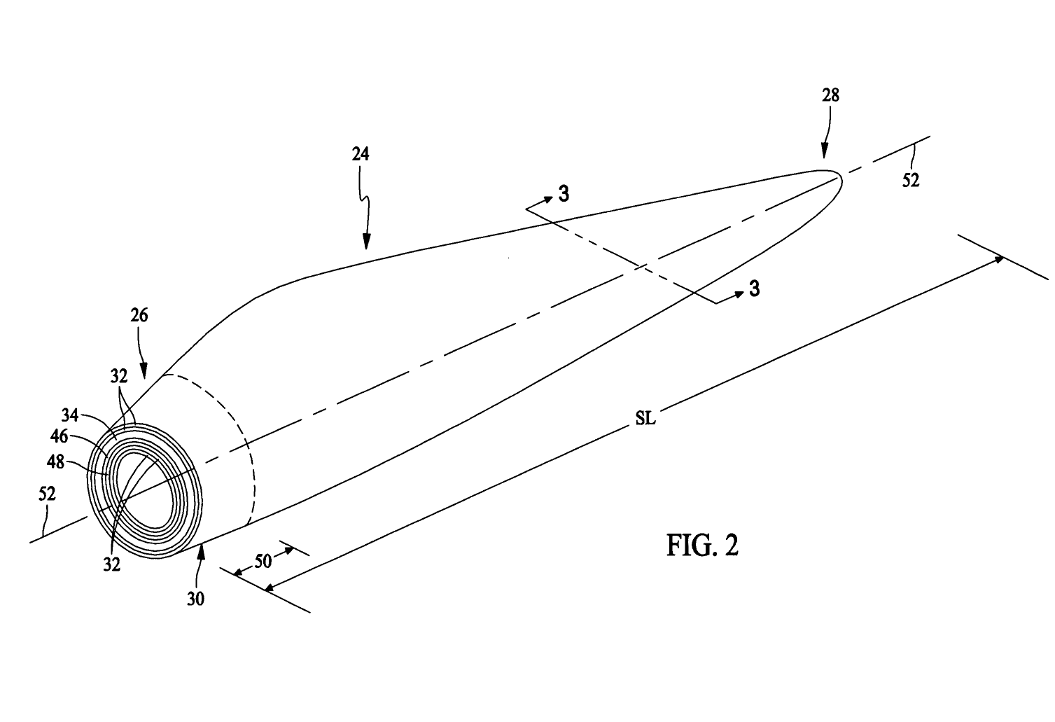

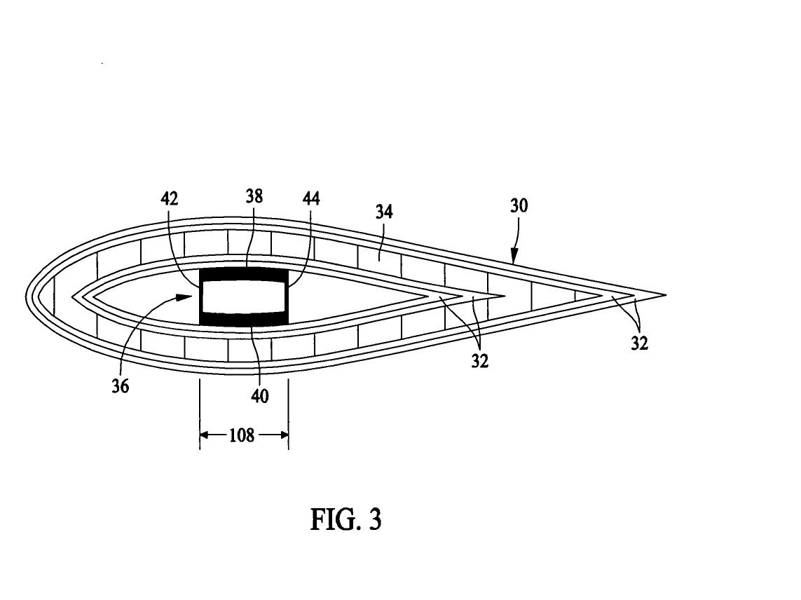

FIG. 2 is a perspective view of an exemplary rotor blade 24 for use with wind turbine 10 (shown in FIG. 1). FIG. 3 is a cross-sectional view of rotor blade 24 taken about line 3-3 of FIG. 2. A composite shell 30 of blade 24 is sometimes fabricated using a plurality of layers 32 of material laminated together with a resin, such as, but not limited to, an epoxy, a vinylester, and/or a polyester resin. Each layer 32 may include any suitable material(s), such as, but not limited to, metal, plastic, wood, and/or fiber, such as, but not limited to, glass fiber, carbon fiber, and/or aramid fiber. Shell 30 may also include other component layers laminated with layers 32. For example, exemplary shell 30 of exemplary blade 24 includes core material 34 sandwiched between two adjacent layers 32 to facilitate strengthening shell 30 and/or blade 24 generally, for example to support shell 30 and/or blade 24 generally against buckling due to wind loading. Although four layers 32 are shown, shell 30 may include any number of layers 32. Moreover, although only one layer of core material 34 is shown, and although core material 34 is shown as sandwiched between two adjacent layers 32, shell 30 may include any number of layers core material 34 each positioned anywhere within shell 30 enabling core material 34 to function as described herein. Furthermore, although core material 34 is shown as thicker than each layer 32, each layer of core material 34 may have any suitable thickness enabling core material to function as described herein, whether larger, smaller, and/or substantially the same as one or more layers 32. Similarly, each layer 32 may have any suitable thickness enabling layers 32 to function as described herein, whether larger, smaller, and/or substantially the same as one or more other layers 32. Core material 34 may include any suitable material(s), such as, but not limited to, balsa wood, PVC foam, Styrene Acryl Nitrate (SAN) foam, PE foam, a metal honeycomb, such as, but not limited to, an aluminum honeycomb, and/or a fabric, such as, but not limited to, a polyester core mat.

To support and/or strengthen shell 30, blade 24 may include one or more internal structural members 36, sometimes referred to as spars. Although structural member(s) 36 may have any suitable location, orientation, structure, configuration, and/or arrangement that enables member(s) 36 to function as described herein, exemplary structural member 36 of exemplary blade 24 is a box-spar that includes two spar caps 38 and 40 (which may sometimes be considered as components of shell 30) that each extend between two shear webs 42 and 44 that support and/or strengthen shell 30. Spar caps 38 and 40 generally support and/or strengthen shell 30 adjacent shear webs 42 and 44 to, for example, facilitate reducing or eliminating damage to blade shell 30 adjacent where webs 42 and 44 connect thereto. Each spar cap 38 and 40 may include one or more layers (not shown), each of any suitable material(s) that enable spar caps 38 and 40 to function as described herein, such as, but not limited to, metal, plastic, wood, and/or fiber, such as, but not limited to, glass fiber, carbon fiber, and/or aramid fiber. For example, spar caps 38 and 40 may include a layer (not shown) of core material, such as, but not limited to, balsa wood, PVC foam, Styrene Acryl Nitrate (SAN) foam, PE foam, a metal honeycomb, such as, but not limited to, an aluminum honeycomb, and/or a fabric, such as, but not limited to, a polyester core mat, sandwiched between two layers (not shown) of fiber. Although shown as having larger thickness than webs 42 and 44, each spar cap 38 and 40 may have a smaller, larger, or substantially equal thickness as webs 42 and/or 44. Each shear web 42 and 44 may include one or more layers (not shown), each of any suitable material(s) that enables shear webs 42 and 44 to function as described herein, such as, but not limited to, metal, plastic, wood, and/or fiber, such as, but not limited to, glass fiber, carbon fiber, and/or aramid fiber. For example, shear webs 42 and 44 may include a layer (not shown) of core material, such as, but not limited to, balsa wood, PVC foam, Styrene Acryl Nitrate (SAN) foam, PE foam, a metal honeycomb, such as, but not limited to, an aluminum honeycomb, and/or a fabric, such as, but not limited to, a polyester core mat, sandwiched between two layers (not shown) of fiber. Although shear webs 42 and 44 are each illustrated in FIG. 3 at a particular exemplary location along a chord length CL of blade 24, shear webs 42 and 44 may each be located at any suitable chord length enabling shear webs 42 and 44 to function as described herein. Structural member(s) 36, including webs 42 and 44 and/or spar caps 38 and 40, may extend along an entire span length SL of blade 24. Alternatively, structural member(s) 36, including webs 42 and 44 and/or spar caps 38 and 40, may extend along only a portion of blade span length SL.

To support and/or strengthen shell 30 adjacent root section 26, blade 24 may include one or more additional layers 46 and 48 of material in addition to layers 32 and core material 34. Although two layers 46 and 48 are shown, shell 30 may include any number of additional layers for supporting and/or strengthen shell 30 adjacent root section 26. Moreover, layers 46 and 48 may extend along any portion of blade span length SL. In the exemplary blade 24, layers 46 and 48 extend along a length 50. Layers 46 and 48 provide additional support and/or strength to shell 30 at blade root section 26 to, for example, facilitate reducing or eliminating damage to blade shell 30 adjacent where shell connects to rotor hub 22 (shown in FIG. 1). For example, layers 46 and 48 may provide additional support and/or strength to shell 30 to facilitate reducing or eliminating damage to root section 26 from torque of rotor 18 and/or wind loads acting on blade 24 generally perpendicularly to a longitudinal, or pitch, axis 52, sometimes referred to as shear loads or wind shear. Each layer 46 and 48 may include any suitable material(s) that enable spar layers to function as described herein, such as, but not limited to, metal, plastic, wood, and/or fiber, such as, but not limited to, glass fiber, carbon fiber, and/or aramid fiber.

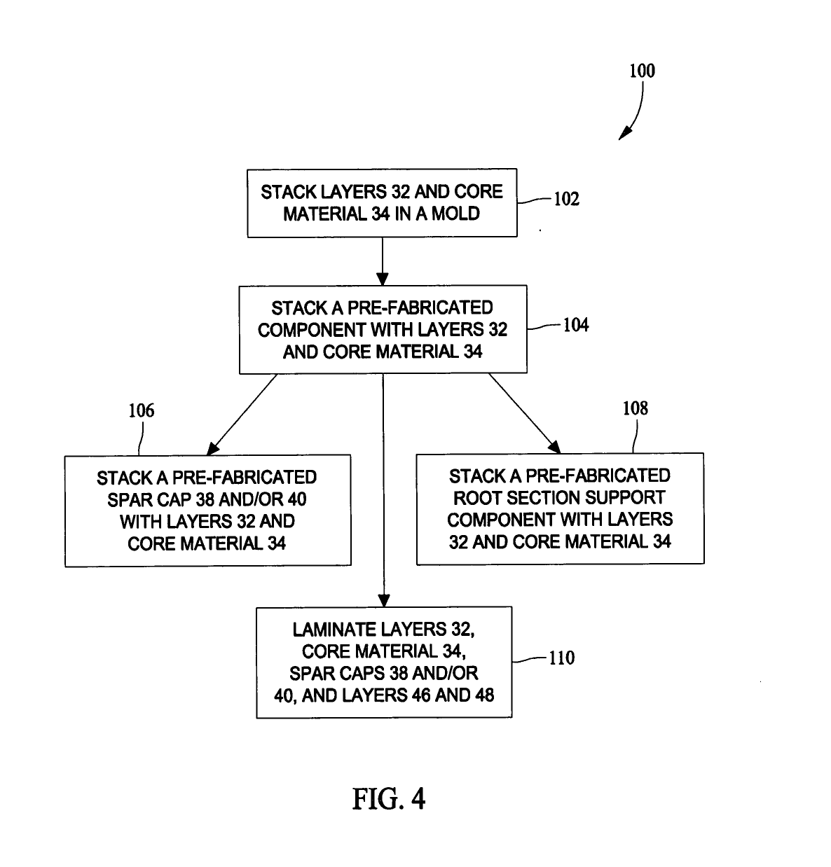

FIG. 4 is a flowchart illustrating an exemplary embodiment of a method 100 for fabricating a blade, for example rotor blade 24 (shown in FIGS. 1-3). Although method 100 may be used to fabricate any portion of blade 24, in the exemplary embodiment method 100 is used to fabricate at least a portion of rotor blade shell 30. Method 100 includes stacking 102 layers 32 and core material 34 in a mold (not shown) that includes a shape corresponding to a predetermined finished shape of a portion or all of rotor blade shell 30. For example, layers 32 and core material 34 may be stacked 102 relative to each other such that they are arranged as shown in FIGS. 2 and 3. Method 100 also includes stacking 104 one or more pre-fabricated components with layers 32 and/or core material 34. The pre-fabricated component(s) is an at least partially finished component of one or more layers, each of any suitable thickness enabling the pre-fabricated component to provide a predetermined function and/or structure within blade shell 30. For example, in the exemplary embodiment the pre-fabricated components are each a composite of a material, such as, but not limited to, one or more layers of fiber, and a cured resin. Moreover, and for example, in some embodiments the pre-fabricated component includes a finished shape that corresponds to a predetermined finished shape of at least a portion of the rotor blade shell. Alternatively, the pre-fabricated component is shaped during lamination.

The pre-fabricated component(s) may be a portion or all of any component of shell 30 and/or a portion or all of any component having any location within, on, and/or adjacent shell 30. In the exemplary embodiment method 100 includes stacking 106 a pre-fabricated spar cap 38 and/or 40 with layers 32 and core material 34 along the portion 108 (shown in FIG. 3) of chord length (CL) (shown in FIG. 3) extending between shear webs 42 and 44 (shown in FIG. 3) and along at least a portion (not shown) of blade span length (SL) (shown in FIG. 2). For example, spar cap(s) 38 and 40 may be stacked 106 relative to layers 32 and core material 34 such that spar cap(s) 38 and 40 are arranged as shown in FIG. 3. Moreover, in the exemplary embodiment method 100 includes stacking 108 a pre-fabricated root section support component composed of pre-fabricated layers 46 and 48 (shown in FIG. 2) with layers 32 and core material 34 along length 50 (shown in FIG. 2). For example, the pre-fabricated layers 46 and 48 may be stacked 108 relative to layers 32 and core material 34 such that layers 46 and 48 are arranged as shown in FIG. 2. In the exemplary embodiment, the pre-fabricated layers 46 and 48 include a finished shape that corresponds to a predetermined finished shape of at least a portion of shell 30. Other examples of pre-fabricated components that may be stacked with layers 32 and/or core material 34 include, but are not limited to, a portion or all of a load bearing spar and/or a portion or all of a trailing edge spar (not shown).

Once stacked, layers 32, core material 34, spar cap(s) 38 and/or 40, and layers 46 and 48 are laminated 110 with a resin to bond them together. Any suitable lamination process may be used, such as, but not limited to, a resin transfer molding (RTM) process, a resin film infusion (RFI) process, heating the stack for any suitable time at any suitable temperature, drying the stack at room temperature and atmospheric pressure for any suitable time, and/or the application of pressure to the stack. In some embodiments, the resin is infused into the stack using pressure, heat, and/or a vacuum bag system (not shown) such as that used with a resin transfer molding process. The pressure and/or vacuum bag system may also facilitate forming the stack into the shape of the mold. In some embodiments, layers 32 and/or core material are prepregged with resin before stacking in the mold. Moreover, in some embodiments layers 32, core material 34, spar cap(s) 38 and/or 40, and/or layers 46 and/or 48 are coated with resin prior to stacking.

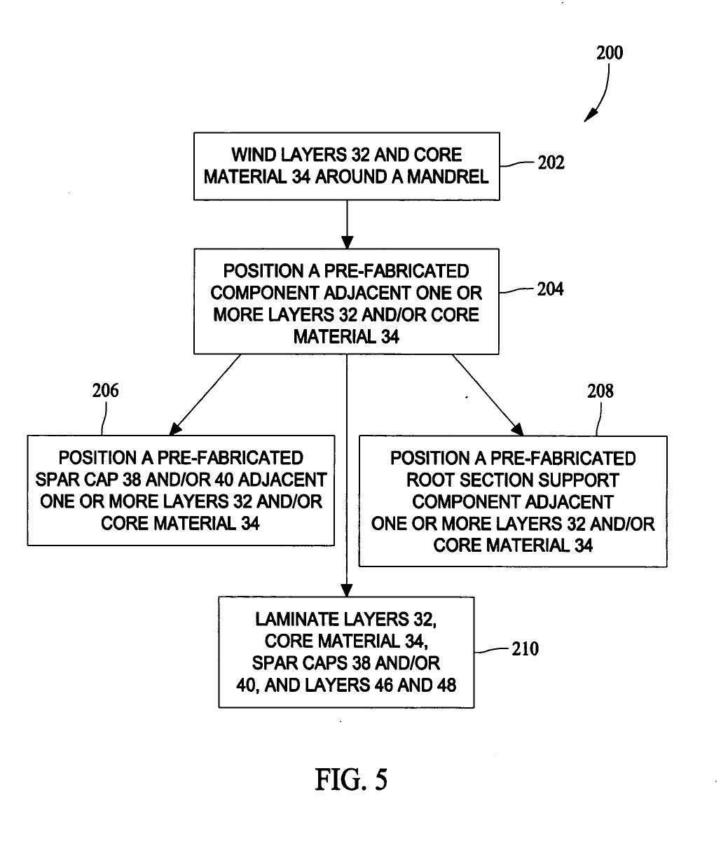

FIG. 5 is a flowchart illustrating an exemplary embodiment of a method 200 for fabricating a blade, for example rotor blade 24 (shown in FIGS. 1-3), using a filament winding process. Although method 200 may be used to fabricate any portion of blade 24, in the exemplary embodiment method 200 is used to fabricate at least a portion of rotor blade shell 30. Method 200 includes winding 202 layers 32 and core material 34 around a mandrel (not shown) that includes a shape corresponding to a predetermined finished shape of a portion or all of rotor blade shell 30 to form a stack of layers 32 and core material 34. For example, layers 32 and core material 34 may wound 202 around the mandrel such that they are stacked such that they are arranged as shown in FIGS. 2 and 3. Method 200 also includes positioning 204 one or more pre-fabricated components adjacent one or more layers 32 and/or core material 34. The pre-fabricated component(s) is an at least partially finished component of one or more layers, each of any suitable thickness enabling the pre-fabricated component to provide a predetermined function and/or structure within blade shell 30. For example, in the exemplary embodiment the pre-fabricated components are each a composite of a material, such as, but not limited to, one or more layers of fiber, and a cured resin. Moreover, and for example, in some embodiments the pre-fabricated component includes a finished shape that corresponds to a predetermined finished shape of at least a portion of the rotor blade shell. Alternatively, the pre-fabricated component is shaped during lamination.

The pre-fabricated component(s) may be a portion or all of any component of shell 30 and/or a portion or all of any component having any location within, on, and/or adjacent to shell 30. In the exemplary embodiment, method 200 includes positioning 206 a pre-fabricated spar cap 38 and/or 40 adjacent one or more layers 32 and/or core material 34 along the portion 108 (shown in FIG. 3) of chord length (CL) (shown in FIG. 3) extending between shear webs 42 and 44 (shown in FIG. 3) and along at least a portion (not shown) of blade span length (SL) (shown in FIG. 2). For example, spar cap(s) 38 and 40 may be positioned 206 relative to layers 32 and core material 34 such that spar cap(s) 38 and 40 are arranged as shown in FIG. 3. Moreover, in the exemplary embodiment method 200 includes positioning 208 a pre-fabricated root section support component composed of pre-fabricated layers 46 and 48 (shown in FIG. 2) adjacent one or more layers 32 and/or core material 34 along length 50 (shown in FIG. 2). For example, the pre-fabricated layers 46 and 48 may be positioned 208 relative to layers 32 and core material 34 such that layers 46 and 48 are arranged as shown in FIG. 2. In the exemplary embodiment, the pre-fabricated layers 46 and 48 include a finished shape that corresponds to a predetermined finished shape of at least a portion of shell 30. Other examples of pre-fabricated components that may be stacked with layers 32 and/or core material 34 include, but are not limited to, a portion or all of a load bearing spar and/or a portion or all of a trailing edge spar (not shown).

Once stacked (wound and positioned), layers 32, core material 34, spar cap(s) 38 and/or 40, and layers 46 and 48 are laminated 110 with a resin to bond them together. Any suitable lamination process may be used, such as, but not limited to, a resin transfer molding (RTM) process, a resin film infusion (RFI) process, heating the stack for any suitable time at any suitable temperature, drying the stack at room temperature and atmospheric pressure for any suitable time, and/or the application of pressure to the stack. In some embodiments, the resin is infused into the stack using pressure, heat, and/or a vacuum bag system (not shown) such as that used with a resin transfer molding process. The pressure and/or vacuum bag system may also facilitate forming the stack into the shape of the mandrel. In some embodiments, layers 32 and/or core material are prepregged with resin before winding and/or positioning on the mandrel. Moreover, in some embodiments layers 32, core material 34, spar cap(s) 38 and/or 40, and/or layers 46 and/or 48 are coated with resin prior to winding and/or positioning.

The herein-described methods are cost-effective and reliable for fabricating rotor blades. For example, by stacking and/or positioning pre-fabricated components with layers of other material(s), the methods described and/or illustrated herein may facilitate increasing a structural integrity of fabricated rotor blades and/or may facilitate increasing quality control over fabricated rotor blades. Moreover, and for example, such pre-fabricated components may facilitate decreasing a fabrication time of rotor blades, which may facilitate increasing a number of rotor blades fabricated within a predetermined amount of time and/or by a single fabrication entity.

Although the methods described and/or illustrated herein are described and/or illustrated herein with respect to rotor blades, and more specifically wind turbine rotor blades, the methods described and/or illustrated herein are not limited to wind turbine rotor blades, nor rotor blades generally. Rather, the methods described and/or illustrated are applicable to fabricating any blade or airfoil.

Exemplary embodiments of methods are described and/or illustrated herein in detail. The methods are not limited to the specific embodiments described herein, but rather, steps of each method may be utilized independently and separately from other steps described herein. Each method's steps can also be used in combination with other method steps, whether described and/or illustrated herein.

When introducing elements of the methods described and/or illustrated herein, the articles “a”, “an”, “the” and “said” are intended to mean that there are one or more of the elements. The terms “comprising”, “including” and “having” are intended to be inclusive and mean that there may be additional elements other than the listed elements.

While the invention has been described in terms of various specific embodiments, those skilled in the art will recognize that embodiments (whether described and/or illustrated herein) of the present invention can be practiced with modification within the spirit and scope of the claims.

What is claimed is:

1. A method for fabricating a blade using a mold having a shape corresponding to a predetermined finished shape of at least a portion of the blade, said method comprising:
stacking a plurality of layers of a material in the mold;
stacking at least one component with the stack of the plurality of layers, wherein the component is a composite comprising a cured resin and at least one layer of fiber; and
laminating the stack of the plurality of layers and the component.

2. A method in accordance with claim 1 further comprising, before stacking the component, fabricating the component by interspersing the resin with the layer of fiber and curing the resin.

3. A method in accordance with claim 1 wherein the layer of fiber is a first layer of fiber and stacking a plurality of layers of a material in the mold comprises at least one of:
stacking at least one second layer of fiber in the mold; and
stacking at least one layer of wood in the mold.

4. A method in accordance with claim 1 wherein stacking at least one component with the stack of the plurality of layers comprises stacking the component at least partially between two adjacent layers of the plurality of layers.

5. A method in accordance with claim 1 wherein stacking at least one component with the stack of the plurality of layers comprises stacking at least one of a spar cap and a root section support component with the stack of the plurality of layers.

6. A method in accordance with claim 1 further comprising prepregging at least one layer of the plurality of layers with resin before stacking the plurality of layers in the mold.

7. A method in accordance with claim 1 wherein laminating comprises at least one of:
infusing resin into at least one layer of the plurality of layers;
heating the stack of the plurality of layers and the component; and
applying pressure to the stack of the plurality of layers and the component.

8. A method in accordance with claim 1 wherein laminating comprises laminating the stack of the plurality of layers and the component using a resin transfer molding (RTM) process.

9. A method in accordance with claim 1 wherein laminating comprises laminating the stack of the plurality of layers and the component using a resin film infusion (RFI) process;

10. A method for fabricating a blade using a mold having a shape corresponding to a predetermined finished shape of at least a portion of the blade, said method comprising:
stacking a plurality of layers of a material in the mold;
stacking at least one component with the stack of the plurality of layers, wherein the component comprises a shape that corresponds to the predetermined finished shape of at least a portion of the blade; and
laminating the stack of the plurality of layers and the component.

11. A method in accordance with claim 10 further comprising, before stacking the component, fabricating the component by interspersing resin with at least one layer of fiber and curing the resin.

12. A method in accordance with claim 10 wherein stacking a plurality of layers of a material in the mold comprises at least one of:
stacking at least one layer of fiber in the mold; and
stacking at least one layer of wood in the mold.

13. A method in accordance with claim 10 wherein stacking at least one component with the stack of the plurality of layers comprises stacking the component at least partially between two adjacent layers of the plurality of layers.

14. A method in accordance with claim 10 wherein stacking at least one component with the stack of the plurality of layers comprises stacking at least one of a spar cap and a root section support component with the stack of the plurality of layers.

15. A method in accordance with claim 10 further comprising prepregging at least one layer of the plurality of layers with resin before stacking the plurality of layers in the mold.

16. A method in accordance with claim 10 wherein laminating comprises at least one of:
infusing resin into at least one layer of the plurality of layers;
heating the stack of the plurality of layers and the component; and
applying pressure to the stack of the plurality of layers and the component.

17. A method in accordance with claim 10 wherein laminating comprises laminating the stack of the plurality of layers and the component using a resin transfer molding (RTM) process.

18. A method in accordance with claim 10 wherein laminating comprises laminating the stack of the plurality of layers and the component using a resin film infusion (RFI) process.

19. A method for fabricating a blade using a filament winding process, said method comprising:
providing a mandrel having a shape corresponding to a predetermined finished shape of at least a portion of the blade;
winding fiber around the mandrel to form a plurality of layers of the fiber;
positioning at least one component adjacent at least one layer of the plurality of layers of fiber, wherein the component comprises at least one of a shape that corresponds to the predetermined finished shape of at least a portion of the blade and at least one layer of fiber infused with a cured resin; and
laminating the plurality of fiber layers and the component.

20. A method in accordance with claim 19 further comprising, before positioning the component, fabricating the component by interspersing resin with at least one other layer of fiber and curing the resin.
